(19) United States
(12) Patent Application Publication
(10) Pub. No.: US 2024/0350371 A1
(43) Pub. Date: Oct. 24, 2024

(54) Device for retaining a pacifier

(71) Applicant: Artsana S.p.A., Grandate CO (IT)

(72) Inventors: Daniela CORONATI, Grandate CO (IT); Giulia CICCIARELLA, Como (IT); Virginia DORIA, Como (IT); Sara GALFRASCOLI, Como (IT)

(21) Appl. No.: 18/632,454

(22) Filed: Apr. 11, 2024

(30) Foreign Application Priority Data
Apr. 21, 2023 (IT) 102023000007950

(51) Int. Cl. A61J 17/00

(52) U.S. Cl. CPC A61J 17/001; A61J 17/111

(57) ABSTRACT

Device for retaining a pacifier, comprising a central body extending at least along a main direction between a first end and a second end, an annular retaining element constrained at the first end of the central body, made of elastically deformable material and couplable to a handle of the pacifier, wherein the central body has a coupling portion in proximity of the second end, the annular retaining element has a first coupling configuration in which the annular retaining element is adapted to internally receive and surround at least part of the handle of the pacifier when the pacifier is of the type with button handle, and a second coupling configuration in which the annular retaining element is configured to reversibly couple with the coupling portion of the central body retaining the handle of the pacifier when the pacifier is of the type with ring handle.

### FIELD OF THE DISCLOSURE

The present disclosure relates to a device for retaining a pacifier capable of retaining the pacifier in proximity of an item of clothing of a child. The present disclosure also relates to a clip comprising said device. The present disclosure relates to an assembly for retaining a pacifier, comprising a pacifier and said clip.

### DESCRIPTION OF THE PRIOR ART

It is known in the art to manufacture pacifiers or soothers for children equipped with a handle having a shape depending on the child's age. In particular, pacifiers or soothers comprising a ring handle for the first months of life are known. The pacifiers with ring handle allow the child to interact with and approach the pacifier, by inserting their fingers into the ring to hold it in their hand. There are also known pacifiers with a button handle, suitable for children from 6 to 18 months, to allow the child to learn to grasp and hold the pacifier correctly with their fingers.

It is also known in the art to manufacture clips or devices capable of engaging the handle of the pacifier and securely couple to a child's item of clothing, by means of a clasp, so that the child is allowed to access the pacifier quickly and easily.

In greater detail, systems comprising a hook or a carabiner clip capable of coupling to the ring handle of the pacifier are known.

In the prior art, pacifier retaining systems are also known comprising a ring capable of surrounding and retaining the button handle of the pacifier.

An example of a pacifier retaining system is shown in document US 2011/0266319 A1, which describes a clip device for retaining different types of pacifiers.

### Problem of the Prior Art

The known devices for retaining the pacifier are manufactured according to a specific handle of the pacifier. In fact, each type of handle of the pacifier requires a specific device to retain the pacifier, which is capable of reversibly engage with the handle itself. Therefore, it is necessary for a family member or caregiver to always have the specific device available for each pacifier used by the child. As a result, the known devices are impractical and cannot adequately be adapted to the needs of the child and the child's family member or caregiver.

### SUMMARY OF THE DISCLOSURE

The object of the disclosure in question is to make a device for retaining a pacifier that overcomes the drawbacks of the prior art.

In particular, the object of the present disclosure is to make a device for retaining a pacifier that is adaptable both to a pacifier having a ring handle and to a pacifier having a button handle.

The technical task mentioned and the objects stated are substantially achieved by a device comprising the technical features set out in one or more of the appended claims.

### Advantages of the Disclosure

Thanks to an embodiment, it is possible to obtain a device for retaining a pacifier that is of a universal type, i.e. having a retaining element capable of coupling according to two different coupling configurations respectively to the handle of a button pacifier or of a ring pacifier. In greater detail, it is possible to manufacture a device comprising an annular retaining element, made of flexible and elastically deformable material, capable of adapting to the two coupling configurations.

Advantageously, the annular retaining element can be elastically deformed in the radial direction to surround and retain the button of a pacifier having a button handle.

Still advantageously, the device for retaining a pacifier comprises a coupling portion for retaining the annular retaining element of the device, so as to allow a deformation of the annular retaining element according to one of the two coupling configurations for retaining a pacifier having a ring handle.

### BRIEF DESCRIPTION OF THE DRAWINGS

The features and advantages of the present disclosure will become apparent from the following detailed description of a possible practical embodiment thereof, illustrated by way of non-limiting example in the accompanying drawings, in which:

FIG. 1 schematically shows a view of the device for retaining a pacifier according to the present disclosure;

FIG. 2 schematically shows a further view of the device of FIG. 1;

FIG. 3 schematically shows an example of application of the device of FIG. 1;

FIG. 4 schematically shows a view of the device of FIG. 3;

FIG. 5 schematically shows a further example of application of the device of FIG. 1;

FIG. 6 schematically shows a view of the device of FIG. 5;

FIG. 7 schematically shows a clip according to the present disclosure.

### DETAILED DESCRIPTION

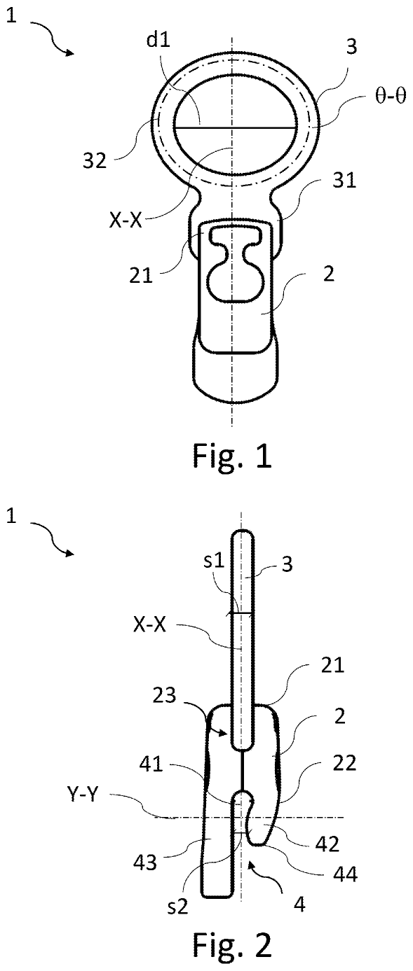

The present disclosure relates to a device 1 for retaining a pacifier 5 shown in FIG. 1.

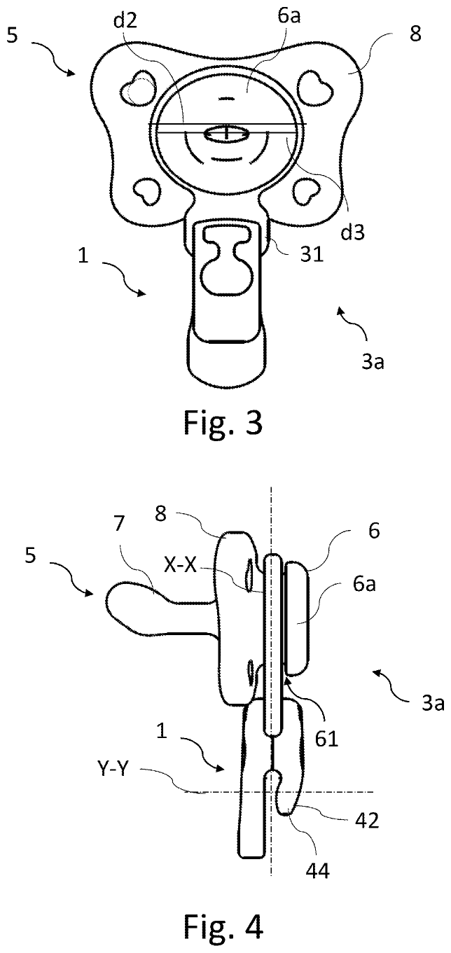

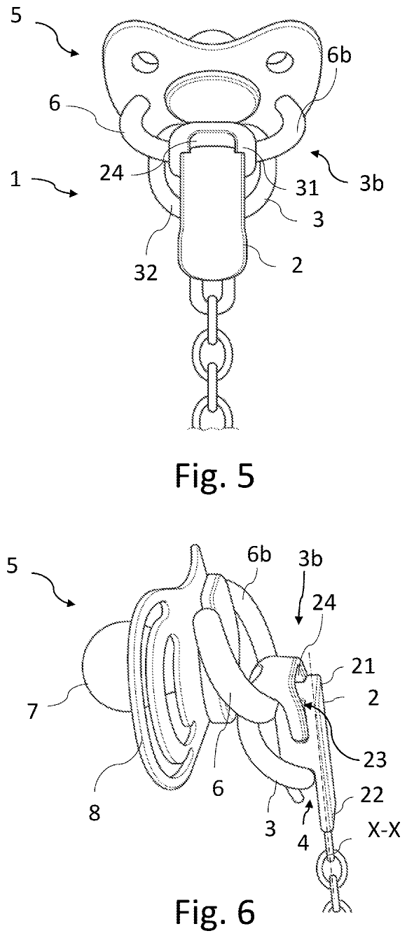

For the purposes of the present disclosure, the pacifier 5 is of the type comprising a teat 7, a shield 8 connected to the teat and a handle 6 projecting from the shield 8 in the opposite direction to the teat 7, as can be seen in FIGS. 3 and 4. The handle 6 of the pacifier 5 can be of the button type 6a, as can be seen in FIGS. 3 and 4 or, alternatively, of the ring type 6b, as can be seen in FIGS. 5 and 6.

The device 1 for retaining the pacifier 5 comprises a central body 2 extending at least along a main direction X-X between a first end 21 and a second end 22 opposite to the first end 21. Preferably, the central body 2 is made of rigid material. More preferably, the central body 2 is made of plastic.

The central body 2 has a coupling portion 4 in proximity of the second end 22.

The device 1 further comprises an annular retaining element 3 constrained at the first end 21. The annular retaining element 3 is made of elastically deformable and, therefore, flexible material. Preferably, the annular retaining element 3 is made of silicone.

The annular retaining element 3 is couplable to the handle of the pacifier 6 by elastic deformation, as shown in the united figures. The annular retaining element 3 has a first coupling configuration 3a and a second coupling configuration 3b, shown respectively in FIGS. 3-4 and 5-6.

In the first coupling configuration 3a the annular retaining element 3 internally receives and surround at least part of the handle 6 of the pacifier 5 when the pacifier 5 is of the type with button handle 6a. In other words, the annular retaining element 3 is adapted to deform circumferentially, elastically widening to at least partially accommodate the pacifier handle 6 therein and narrowing to at least partially retain the pacifier handle 6 therein, as further detailed in the following of the present description.

Preferably, the annular retaining element 3 has an outer diameter d2 and an inner diameter d1. Also preferably, the inner diameter d1 is smaller than a diameter d3 of the button 6a of the handle 6.

According to the preferred embodiment of the disclosure, in the first coupling configuration 3a, illustrated in FIGS. 3 and 4, the annular retaining element 3 elastically deforms around the button 6a of the handle 6, increasing its inner diameter d1 to surround the button 6a. Thanks to an elastic return force, the annular retaining element 3 tends to return substantially to the non-deformed conformation, i.e. its inner diameter d1 tends to return substantially to its original dimensions, so as to encircle and retain the handle 6 inserted internally to the annular retaining element 3. Preferably, the annular retaining element 3 is inserted into an annular seat 61 of the handle 6, in such a way as to reversibly retain the pacifier 5.

In the second coupling configuration 3b, illustrated in FIGS. 5 and 6, the annular retaining element 3 reversibly couples with the coupling portion 4 of the central body 2 and retains the handle 6 of the pacifier when the pacifier 5 is of the type with a ring handle 6b.

According to the preferred embodiment of the disclosure, in the second coupling configuration 3b, the annular retaining element 3 elastically deforms into a ring conformation, illustrated in FIGS. 5 and 6. It should be noted that the annular retaining element 3 is inserted and passes internally to the ring 6b of the handle 6, in such a way that, when it is coupled to the coupling portion 4 of the central body 2, it is reversibly concatenated to the ring 6b of the handle 6. In other words, the annular retaining element 3, deformed in the ring conformation, is intertwined and passes internally to the ring 6b of the handle 6. In further detail, the annular retaining element 3 passing internally to the ring 6b, deforms along the main direction X-X in a direction defined by the first end 21 to the second end 22 of the central body 2, in such a way as to couple with the coupling portion 4 and remain reversibly locked in the ring conformation.

In the context of the present disclosure, a concatenated or intertwined element means an element joined in a chain to a further element of annular shape. In other words, it is understood to mean an element that intersects a further element establishing a connection similar to that present between two links of a chain.

For the purposes of the present disclosure, by ring conformation is meant a deformation such that the annular retaining element 3 is deformed and coupled to the coupling portion 4 of the central body 2, forming a further ring between the portion of the annular retaining element 3 fixed to the first end 21 of the annular body 2 and the portion of the annular retaining element 3 coupled to the coupling portion 4.

According to the preferred embodiment of the disclosure, shown in FIG. 2, the coupling portion 4 has a retaining seat 41 adapted to receive, at least in part, the annular retaining element 3. Preferably, the retaining seat 41 has transversely a narrowing s2 in the main direction X-X. Still preferably, the narrowing s2 is formed along the main direction X-X away from the first end 21 of the central body 2. Still preferably, the annular retaining element 3 has at least one thickness s1 greater than the narrowing s2.

It should be noted that the annular retaining element 3, by deforming along a circumferential direction θ-θ, is insertable into the retaining seat 41 through the narrowing s2. In this way, the annular retaining element 3 remains reversibly locked within the retaining seat 41 by the narrowing s2.

According to the preferred embodiment of the disclosure, illustrated in FIG. 2, the coupling portion 4 comprises a first arm 42 and a second arm 43. Preferably, the first arm 42 and the second arm 43 extend at least along the main direction X-X and are spaced along a transverse direction Y-Y perpendicular to the main direction X-X.

Still preferably, the retaining seat 41 is defined transversely between the first arm 42 and the second arm 43. Still preferably, the first arm 42 has a free end 44 approached in a direction transverse to the second arm 43, such that the free end 44 of the first arm 42 and the second arm 43 define the narrowing s2 of the retaining seat 41. In addition, or alternatively, the free end 44 of the first arm 42 comprises a thickening in the transverse direction Y-Y towards the second arm 43. Preferably, said thickening defines at least in part the narrowing s2 of the retaining seat 41.

According to the preferred embodiment of the disclosure, illustrated in the attached figures, the annular retaining element 3 comprises a connection portion 31 fixed to the first end 21 of the central body 2. In addition, the annular retaining element 3 comprises a ring 32 connected to the connection portion 31 and adapted to be coupled according to the first coupling configuration or according to the second coupling configuration to the handle 6 of the pacifier 5. Note that the thickness s1 of the annular retaining element 3 is defined by the thickness of the ring 32 of the annular retaining element 3.

Preferably, as shown in FIG. 6, the first end 21 of the central body 2 comprises a through hole 23 internally receiving at least part of the connection portion 31 of the annular retaining element 3. Still preferably, as shown in FIGS. 5 and 6, the connection portion 31 has an opening 24. Still preferably, the connection portion 31 and the first end 21 of the central body 2 are concatenated to each other through the through hole 23 and the opening 24.

According to the preferred embodiment of the disclosure, the first end 21 of the central body 2 is moulded directly surrounding the opening 24 of the connection portion 31, so as to irreversibly concatenate the connection portion 31 with the free end 21 of the central body 2, unless at least one of the two portions involved breaks.

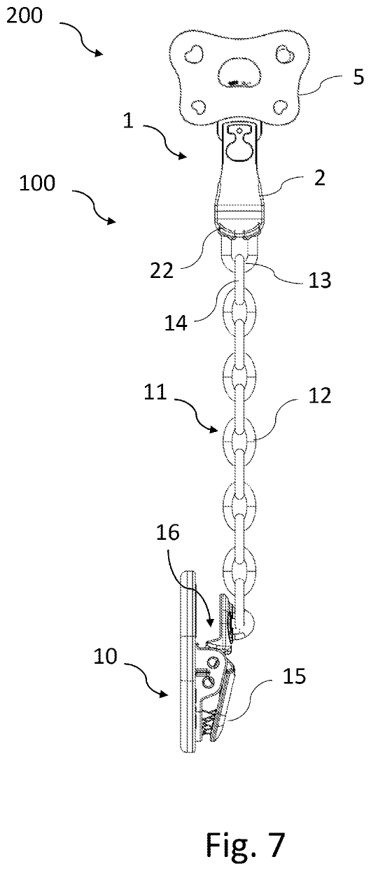

A further object of the present disclosure is a clip 100 for retaining a pacifier 5, illustrated in FIG. 7.

The clip 100 comprises a device 1 for retaining a pacifier 5 according to the present disclosure.

Furthermore, the clip 100 comprises a clasp 10 connected to the second end 22 of the central body 2 of the device 1 and adapted to engage with an item of clothing or any piece of fabric or cloth, not illustrated.

Preferably, as shown in FIG. 7, the clasp 10 comprises a pair of arms 15 switchable between a rest, or closing, configuration, illustrated in FIG. 7, and at least one opening configuration, not illustrated, by rotation about a pin 16. Also preferably, the clasp 10 has a spring operation capable of returning the pair of arms 15 from the opening configuration to the closing configuration.

The clip 100 comprises connection members 11 connecting the device 1 to the clasp 10. Preferably, the connection members 11 comprises a little chain 12. Still preferably, the second end 22 of the central body 2 has a first link 13. The little chain 12 comprises at least one link 14 concatenated to the first link 13.

A further object of the present description is an assembly 200 for retaining a pacifier 5.

The assembly 200 comprises a pacifier 5 having the handle 6 of the ring type 6b or of the button type 6a.

The assembly 200 further comprises a clip 100 for retaining the pacifier 5 according to the present disclosure.

The annular retaining element 3 of the device 1 of the clip 100 is couplable according to the first coupling configuration 3a to the button 6a of the handle 6 or according to the second coupling configuration 3b to the ring 6b of the handle 6.

1. Device for retaining a pacifier, comprising:
a central body extending at least along a main direction between a first end and a second end opposite to the first end,
an annular retaining element constrained to the first end of the central body and made of elastically deformable material, the annular retaining element being attachable to a pacifier handle elastically deforming,
wherein:
the central body has a coupling portion in proximity of the second end, and
the annular retaining element has a first coupling configuration and a second coupling configuration, wherein:
in the first coupling configuration the annular retaining element is adapted to internally receive and surround at least part of the handle of the pacifier when the pacifier is of the type with button handle,
in the second coupling configuration the annular retaining element is configured to reversibly couple with the coupling portion of the central body, the annular retaining element in the second coupling configuration retaining the handle of the pacifier when the pacifier is of the type with ring handle,
wherein:
the coupling portion comprises a first arm and a second arm, the first arm and the second arm extending at least along the main direction and being spaced along a transverse direction perpendicular to the main direction, and
the coupling portion has a retaining seat defined transversely between the first arm and the second arm and adapted to receive at least in part the annular retaining element.

2. Device according to claim 1, wherein, in the second coupling configuration, the annular retaining element is configured to elastically deform into a ring conformation, the annular retaining element passing internally to the ring of the handle of the pacifier and being reversibly concatenate to the ring of the handle of the pacifier.

3. Device according to claim 1, wherein the annular retaining element has an inner diameter smaller than a diameter of the button of the handle of the pacifier, the annular retaining element in the first coupling configuration elastically deforming around the button of the handle of the pacifier, the annular retaining element inserting into an annular seat of the handle of the pacifier.

4. Device according to claim 1, wherein the retaining seat has a narrowing along the main direction, the annular retaining element having a thickness greater than the narrowing.

5. Device according to claim 1, wherein the annular retaining element comprises a connection portion, the connection portion being fixed to the first end of the central body.

6. Device according to claim 5, wherein the first end of the central body comprises a through hole internally receiving at least part of the connection portion of the annular retaining element.

7. Clip for retaining a pacifier, comprising:
a device for retaining a pacifier comprising:
a central body extending at least along a main direction between a first end and a second end opposite to the first end,
an annular retaining element constrained to the first end of the central body and made of elastically deformable material, the annular retaining element being attachable to a pacifier handle elastically deforming,
wherein:
the central body has a coupling portion in proximity of the second end, and
the annular retaining element has a first coupling configuration and a second coupling configuration, wherein:
in the first coupling configuration the annular retaining element is adapted to internally receive and surround at least part of the handle of the pacifier when the pacifier is of the type with button handle,
in the second coupling configuration the annular retaining element is configured to reversibly couple with the coupling portion of the central body, the annular retaining element in the second coupling configuration retaining the handle of the pacifier when the pacifier is of the type with ring handle,
wherein:
the coupling portion comprises a first arm and a second arm, the first arm and the second arm extending at least along the main direction and being spaced along a transverse direction perpendicular to the main direction, and
the coupling portion has a retaining seat defined transversely between the first arm and the second arm and adapted to receive at least in part the annular retaining element,
a clasp connected to the second end of the central body of the device and adapted to engage with an item of clothing,
connection members connecting the device to the clasp.

8. Assembly for retaining a pacifier, comprising:
a pacifier provided with a teat, a shield connected to the teat and a handle opposite to the teat and projecting from the shield, the handle of the pacifier being of the ring type or of the button type,
a clip for retaining the pacifier comprising:
a device for retaining a pacifier comprising:
a central body extending at least along a main direction between a first end and a second end opposite to the first end,
an annular retaining element constrained to the first end of the central body and made of elastically deformable material, the annular retaining element being attachable to a pacifier handle elastically deforming,
wherein:
the central body has a coupling portion in proximity of the second end, and
the annular retaining element has a first coupling configuration and a second coupling configuration, wherein:
in the first coupling configuration the annular retaining element is adapted to internally receive and surround at least part of the handle of the pacifier when the pacifier is of the type with button handle,
in the second coupling configuration the annular retaining element is configured to reversibly couple with the coupling portion of the central body, the annular retaining element in the second coupling configuration retaining the handle of the pacifier when the pacifier is of the type with ring handle,
wherein:
the coupling portion comprises a first arm and a second arm, the first arm and the second arm extending at least along the main direction and being spaced along a transverse direction perpendicular to the main direction, and
the coupling portion has a retaining seat defined transversely between the first arm and the second arm and adapted to receive at least in part the annular retaining element,
a clasp connected to the second end of the central body of the device and adapted to engage with an item of clothing,
connection members connecting the device to the clasp,
wherein the annular retaining element of the device of the clip is attachable according to the first coupling configuration to the button of the pacifier handle or according to the second coupling configuration to the ring of the pacifier handle.
